(19) United States
(12) Patent Application Publication
(10) Pub. No.: US 2008/0216573 A1
(43) Pub. Date: Sep. 11, 2008

(54) Semiconductor acceleration sensor

(75) Inventor: Kenji Katou, Miyazaki (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/073,198

(22) Filed: Mar. 3, 2008

(30) Foreign Application Priority Data
Mar. 9, 2007 (JP) 2007-060149

(51) Int. Cl. G01P 15/12

(52) U.S. Cl. 73/514.33

(57) ABSTRACT

According to the present invention, a semiconductor acceleration sensor fabricated using a semiconductor substrate comprises: an outer frame formed by the semiconductor substrate; a plurality of beam portions formed by the semiconductor substrate and connected to the outer frame; a first mass portion formed by the semiconductor substrate and connected to the beam portion; and a second mass portion connected to the end face opposite to the beam portion of the first mass portion. The second mass portion is formed of material having a higher specific gravity than the first mass portion.

### CROSS REFERENCE TO RELATED APPLICATION

This application claims the priority of Application No. 2007-060149, fled Mar. 9, 2007 in Japan, the subject matter of which is incorporated herein by reference.

### TECHNICAL FIELD OF THE INVENTION

The present invention relates to a semiconductor acceleration sensor fabricated using a semiconductor substrate, and its fabricating method.

### BACKGROUND OF THE INVENTION

A semiconductor sensor detects acceleration by detecting variations in resistance value of piezo resistors that are caused when a flexible section bends due to the change of the position of a mass portion supported by the flexible section in which the piezo resistors are formed. Such a semiconductor sensor is used for measuring acceleration such as that of a running automobile in the running or lateral direction or camera shake of a camcorder.

A conventional three-dimensional acceleration sensor utilizing piezo resistance detection system capable of detecting acceleration in three-axis directions (X, Y and Z) is described using FIGS. 1A, 1B, 2, 3, 4A, 4B, 5A-5E. FIGS. 1A and 1B show the schematic diagrams of a conventional three-dimensional acceleration sensor. This acceleration sensor 10 comprises a semiconductor substrate and is fabricated using semiconductor processing technologies including etching. The entire acceleration sensor is composed of an outer frame 12 and parts of its interior section have through openings 14. The underside of the outer frame 12 is secured to a package or the base of the package (the package and the base are not shown). A mass 18 with a thickness almost equivalent to that of the outer frame 12 is formed at the central portion, and the mass 18 is connected in four directions to the outer frame 12 by four thin beams 16.

Two of the four beams 16 are located with their centerlines positioned in X axis. The other two beams 16 are positioned in Y axis. Piezo resistors 20 for X-axis detection are shown as RX1 to RX4; those resistors 20 for Y-axis detection as RY1 to RY4; and those resistors 20 for Z-axis detection as RZ1 to RZ4. The RX1 to RX4 are formed in the beams 16 positioned in X-axis direction. The RY1 to RY4 and RZ1 to RZ4 are formed in the beams 16 positioned in Y-axis direction. Each of these piezo resistors 20 are positioned near the root of the beams 16 where large stresses are generated when the mass 18 is deformed. In the beams 16 in X-axis direction, the resistors RX1 to RX4 are positioned in the central axis of the beams 16. In the beams 16 in Y-axis direction, the resistors RY1 to RY4 as well as RZ1 to RZ4 are positioned in line, respectively, with a certain interval from the central axis of the beams 16.

Here, the principle of detecting acceleration is briefly described. Acceleration applied to the acceleration sensor 10 in the Z-axis direction moves the mass 18 in parallel to (−)Z direction, as shown in FIG. 2. At this time, tensile stress is generated in the piezo resistors RZ1 and RZ4 positioned closer to the outer frame 12, while compressive stress is generated in the piezo resistors RZ2 and RZ3. According to the degree of the stress, the resistance values of the piezo resistors RZ1 to RZ4 vary. By making up a bridge circuit comprising resistors RZ1 to RZ4 as shown in FIG. 4A, the variation of a resistor value is output as a variation of voltage (Vo1-Vo2) equivalent to the acceleration applied.

Acceleration applied to the acceleration sensor 10 in the (+)Y-axis direction tilts the mass 18 to the Y-axis (X-axis similarly) direction, as shown in FIG. 3. At this time, tensile stress is generated in the piezo resistors RY1(RX1) and RY3(RX3), while compressive stress is generated in the piezo resistors RY2(RX2) and RY4(RX4). By the bridge circuit as shown in FIG. 4B, the variation of a resistor value is output as a variation of voltage (Vo1-Vo2) equivalent to the acceleration applied.

FIGS. 5A-5E are the schematic diagrams showing fabricating processes of a conventional semiconductor three-dimensional acceleration sensor 10. First of all, a semiconductor substrate 11 is prepared (FIG. 5A), and piezo resistors 20 are formed in the proximity of the surface using ion implantation (FIG. 5B). Then the semiconductor substrate 11 is etched from the surface side to form patterns of beams 16 (FIG. 5C).

Then the semiconductor substrate 11 is etched from the back face side so as to make through openings in parts of the same substrate 11 to form patterns of a mass 18 and an outer frame 12 (FIG. 5D). And then, the chip is cut into pieces by dicing or other cutting technique, and the underside of the outer frame 12 is firmly fixed to the bottom of a package 26 and the base secured to the package using dice bonding material 24 (FIG. 5E). Photolithography, which is used for fabricating semiconductor, is used to form patterns in the processes as stated above, thereby realizing high accuracy processing.

Recently, with the reduction in thickness of an apparatus such as cellular phone or notebook PC, however, there is a growing demand for reduction in thickness of an acceleration sensor to be mounted in these apparatuses. One way to reduce the thickness of a sensor is to reduce that of its frame or mass. This, however, reduces the mass of the mass, which may lead to the degradation of sensitivity of the sensor. Reduction in the thickness of mass, in particular, leads to significant degradation of sensitivity in the X- and Y-axis directions compared to that in the Z-axis direction.

If acceleration of 1G is applied in the Z-axis direction in FIG. 1, bending moment applied to the beams 16 is expressed by the product of the length L1 of the beams 16 and the mass m of the mass 18. On the other hand, if acceleration of 1G is applied in the Y(X)-axis direction, bending moment applied to the beams 16 is expressed by the product of the distance L2 from a plane passing through the beams 16 to the center of gravity of the mass 18 and the mass m of the mass 18. That is, since the bending moment is proportional only to the mass m of the mass 18, reducing the thickness of the mass 18 linearly decreases the sensitivity in the Z-axis direction of the sensor. However, since the bending moment is proportional to the distance L2 to the center of gravity of the mass 18 and the mass m of the mass 18, the sensitivity in the Y(X)-axis direction of the sensor is quadrically decreased significantly. This means that reducing the thickness of the mass 18 degrades sensitivity in the X- and Y-directions to be increased more than that in the Z-axis direction, thereby causing the problem of unbalanced sensitivity between the Z-axis direction and the X- and Y-axis directions. Increasing the length L1 of the beams 16 can make the degradation of sensitivity in the X- and Y-axis directions become linearly. However, this causes a problem of increasing the size of the sensor 10 itself.

Not directly related to the present invention, an invention relating to the structure of the mass of an acceleration sensor is disclosed in Japanese Unexamined Patent Application Publication No. 2006-250653.

### OBJECTS OF THE INVENTION

The present invention, taking into account the foregoing situations, has a purpose to provide a semiconductor acceleration sensor contributing to the reduction in the thickness while suppressing the degradation of the sensitivity, and its fabricating method.

Additional objects, advantages and novel features of the present invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

According to a first aspect of the present invention, a semiconductor acceleration sensor fabricated using a semiconductor substrate comprises: an outer frame formed by the semiconductor substrate; a plurality of beam portions formed by the semiconductor substrate and connected to the outer frame; a first mass portion formed by the semiconductor substrate and connected to the beam portion; and a second mass portion connected to the end face opposite to the beam portion of the first mass portion. The second mass portion is formed of material having a higher specific gravity than the first mass portion.

According to a second aspect of the present invention, a method of fabricating a semiconductor acceleration sensor comprises: forming piezo resistors detecting acceleration in X, Y and Z axes, respectively, in the proximity of the surface of a semiconductor substrate; forming four beam portions in which the piezo resistors are formed by processing the semiconductor substrate from the surface side; forming a step difference section in the region where a mass portion will be formed, by processing the semiconductor substrate from the back face side; forming a second mass portion by stacking material having a higher specific gravity than the semiconductor substrate onto a part of the step difference by means of plating; and forming a first mass portion supported by the beam portions by processing the semiconductor substrate from the back face side so as to leave the second mass portion. The mass portion comprises a first mass portion formed by the semiconductor substrate, and the second mass portion.

According to the present invention, since a second mass portion having a higher specific gravity is connected beneath a first mass portion composed of a semiconductor substrate, the thickness of the mass can be reduced without degrading the sensor sensitivity. Furthermore, since the second mass portion can be formed by means of semiconductor fabricating technologies including photolithography, positional shift between the first and the second mass portions can be suppressed and the mass production of sensors with stable characteristics is enabled.

### BRIEF DESCRIPTION OF THE DRAWINGS

FIG. 1A is a schematic plan view of a conventional three-dimensional semiconductor acceleration sensor.

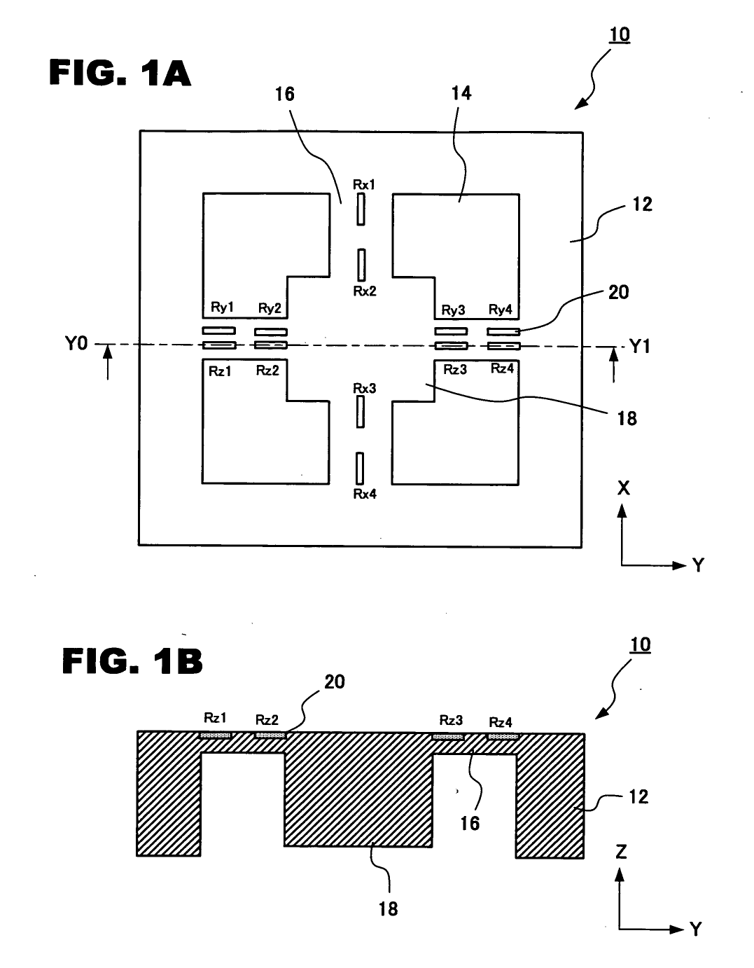

FIG. 1B is a sectional view of the FIG. 1A in Y0-Y1 direction.

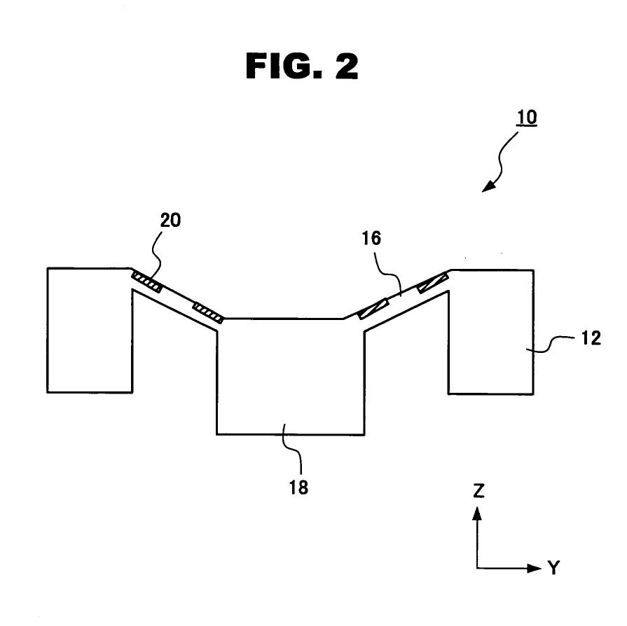

FIG. 2 depicts the principle of a three-dimensional semiconductor acceleration sensor and show a displacement in Z-axis direction.

FIG. 3 depicts the principle of a three-dimensional semiconductor acceleration sensor and shows a displacement in Y-axis direction.

FIGS. 4A and 4B are circuit diagrams depicting the principle of three-dimensional semiconductor acceleration sensor.

FIGS. 5A-5E are sectional views depicting a fabricating process of a conventional three-dimensional semiconductor acceleration sensor.

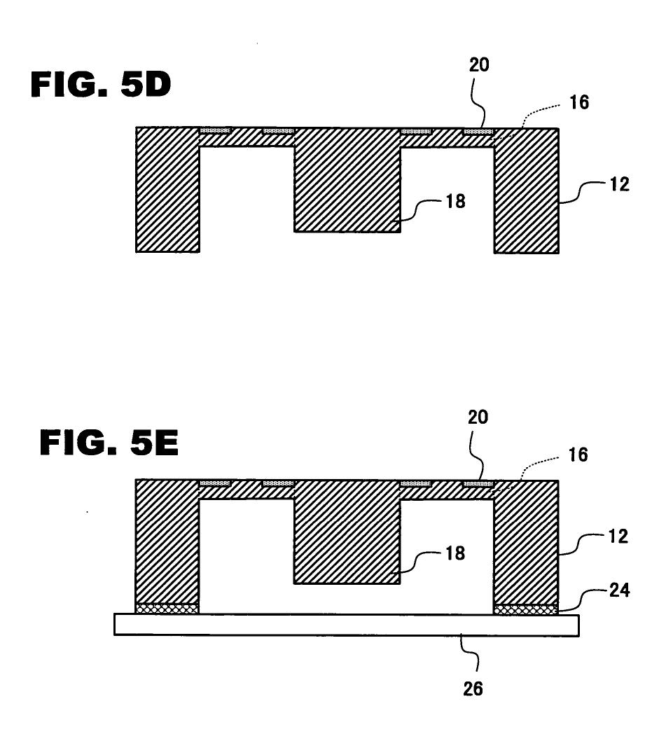

FIG. 6A is a schematic plan view of a three-dimensional semiconductor acceleration sensor related to the present invention.

FIG. 6B is a sectional view of FIG. 6A in Y0-Y1 direction.

FIGS. 7A-7G are sectional views depicting a fabricating process of a three-dimensional semiconductor acceleration sensor related to the present invention.

FIG. 8 is a table showing the thickness of a mass in a three-dimensional semiconductor acceleration sensor related to the present invention.

### REFERENCE NUMERALS

110: three-dimensional semiconductor acceleration sensor
111: Semiconductor substrate
112: Outer frame
116: Beam
118: Mass
118a: First mass portion
118b: Second mass portion
120: Piezo resistor

### DETAILED DISCLOSURE OF THE INVENTION

In the following detailed description of the preferred embodiments, reference is made to the accompanying drawings which form a part hereof, and in which is shown by way of illustration specific preferred embodiments in which the inventions may be practiced. These preferred embodiments are described in sufficient detail to enable those skilled in the art to practice the invention, and it is to be understood that other preferred embodiments may be utilized and that logical, mechanical and electrical changes may be made without departing from the spirit and scope of the present inventions. The following detailed description is, therefore, not to be taken in a limiting sense, and scope of the present inventions is defined only by the appended claims.

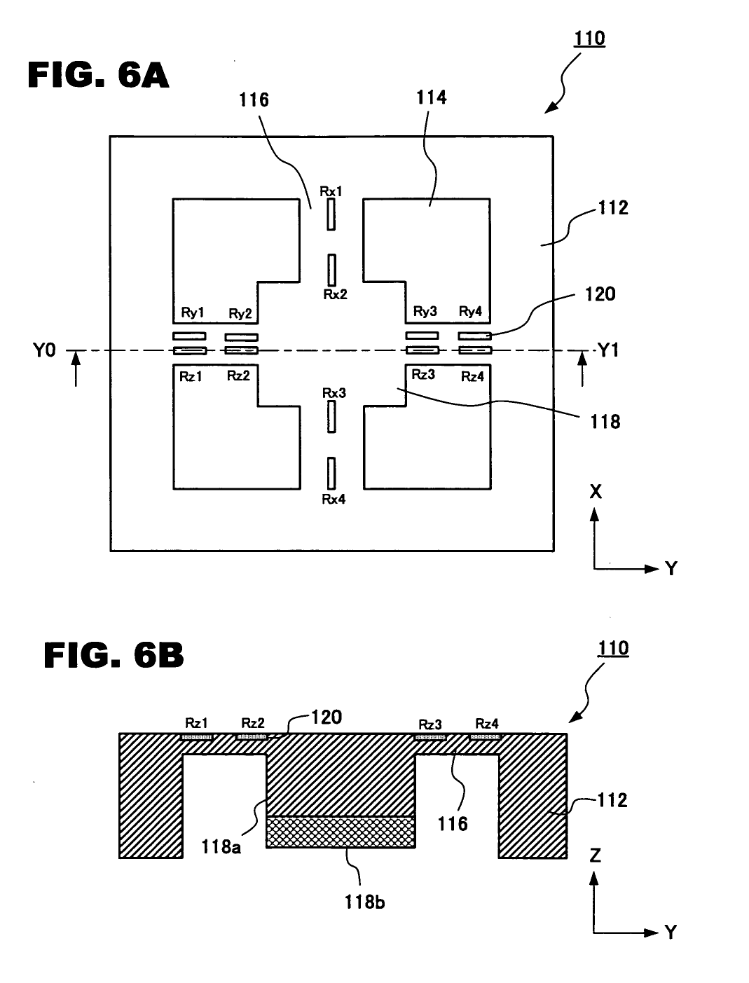

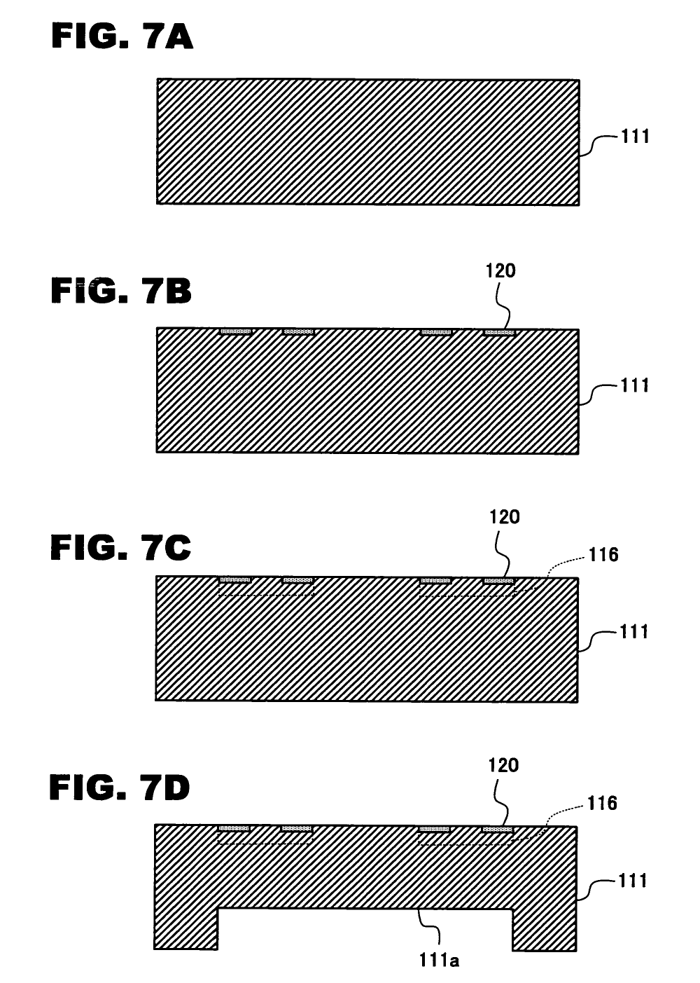

FIGS. 6A and 6B are schematic diagrams of a three-dimensional semiconductor acceleration sensor showing an embodiment of the present invention. An acceleration sensor 110 is composed of a semiconductor substrate and fabricated by means of semiconductor processing technologies including etching. The entire acceleration sensor is composed of an outer frame 112 and parts of its interior section have through openings 114. The underside of the outer frame 112 is secured to a package or the base of the package (the package and the base are not shown). A mass 118 (118a+118b) with a thickness almost equivalent to that of the outer frame 112 is formed at the central portion, and the mass 118 is connected in four directions to the outer frame 112 by four thin beams 116. Here, for a semiconductor substrate, an SOI (Silicon-on-Insulator) substrate in which an insulator film is formed may be used in addition to a substrate formed of semiconductor material alone.

In this embodiment, a mass 118 comprises a first mass portion 118a composed of a semiconductor substrate and a second metallic mass portion 118b formed beneath it (farther from the beam 116). The first beam 118a is formed of semiconductor material such as silicon. On the other hand, the second mass portion 118b is formed of material having a higher specific gravity (density) than semiconductor material, such as metal e.g. gold, copper, tungsten or nickel. By using material having a higher specific gravity than semiconductor material beneath the first mass portion 118a, the mass of the entire mass 118 gets higher than the case in which the mass 118 is formed of silicon alone. Further, the position of the center of gravity of the entire mass 118 can be positioned below the midpoint of the mass 118 in the thickness direction. That is, the position of the center of gravity of the mass 118 can be prevented from being higher even if the thickness of the mass 118 is reduced, thereby enabling the problem of significant degradation of the sensitivity in the X- and Y-axis direction than that in the Z-axis direction to be solved.

Two of the four beams 116 are located with their centerlines positioned in X axis. The other two beams 116 are positioned in Y axis. Piezo resistors 120 for X-axis detection are shown as RX1 to RX4; those for Y-axis detection as RY1 to RY4; and those for Z-axis detection as RZ1 to RZ4. The RX1 to RX4 are formed in the beams 116 positioned in X-axis direction. The RY1 to RY4 and RZ1 to RZ4 are formed in the beams 116 positioned in Y-axis direction. Each of these piezo resistors 120 are positioned near the root of the beams 116 where large stresses are generated when the mass 118 is deformed. In the beams 116 in X-axis direction, the resistors RX1 to RX4 are positioned in the central axis of the beams 116. In the beams 116 in Y-axis direction, the resistors RY1 to RY4 as well as RZ1 to RZ4 are positioned in line, respectively, with a certain interval from the central axis of the beams 116.

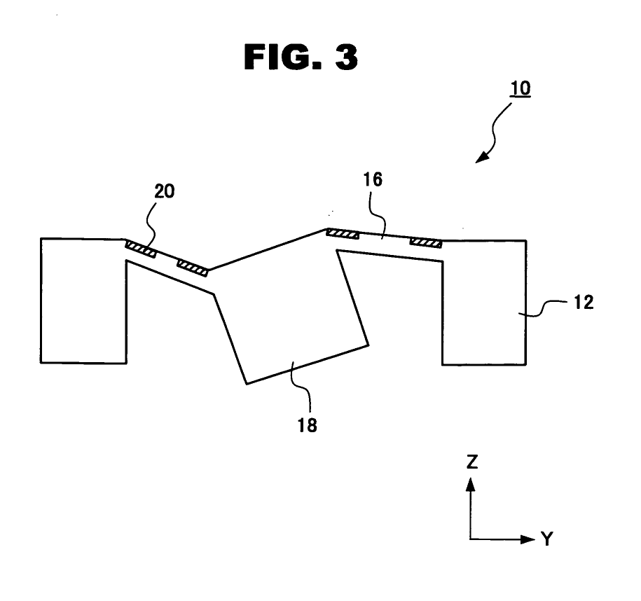

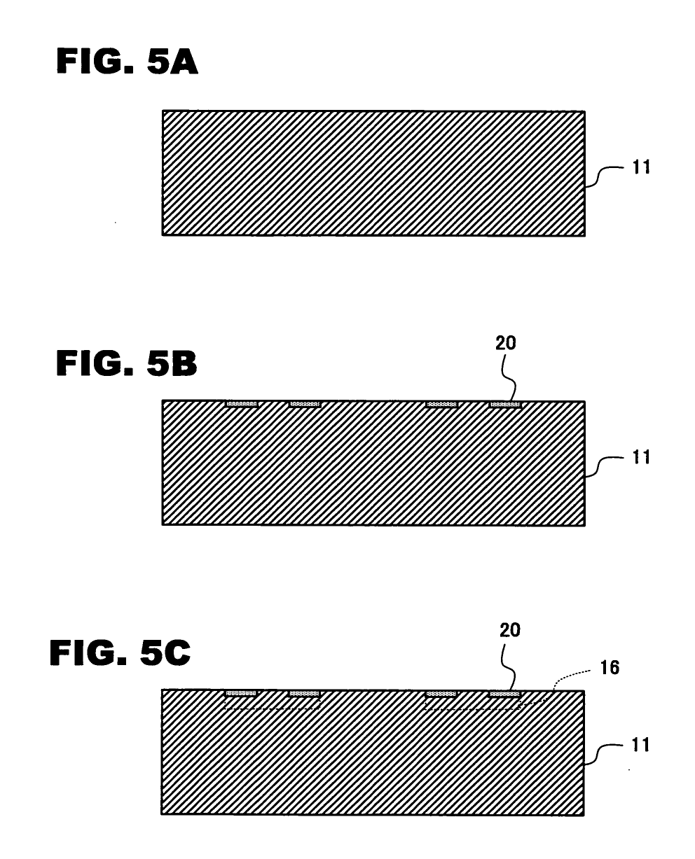

Here, although duplicating the conventional technology, the principle of detecting acceleration is briefly described. Acceleration applied to the acceleration sensor 110 in the Z-axis direction moves the mass 118 in parallel to (−)Z direction, as shown in FIG. 2. At this time, tensile stress is generated in the piezo resistors RZ1 and RZ4 positioned closer to the outer frame 112, while compressive stress is generated in the piezo resistors RZ2 and RZ3. According to the degree of the stress, the resistance values of the piezo resistors RZ1 to RZ4 vary. By making up a bridge circuit comprising resistors RZ1 to RZ4 as shown in FIG. 4A, the variation of a resistor value is output as a variation of voltage (Vo1-Vo2) equivalent to the acceleration applied.

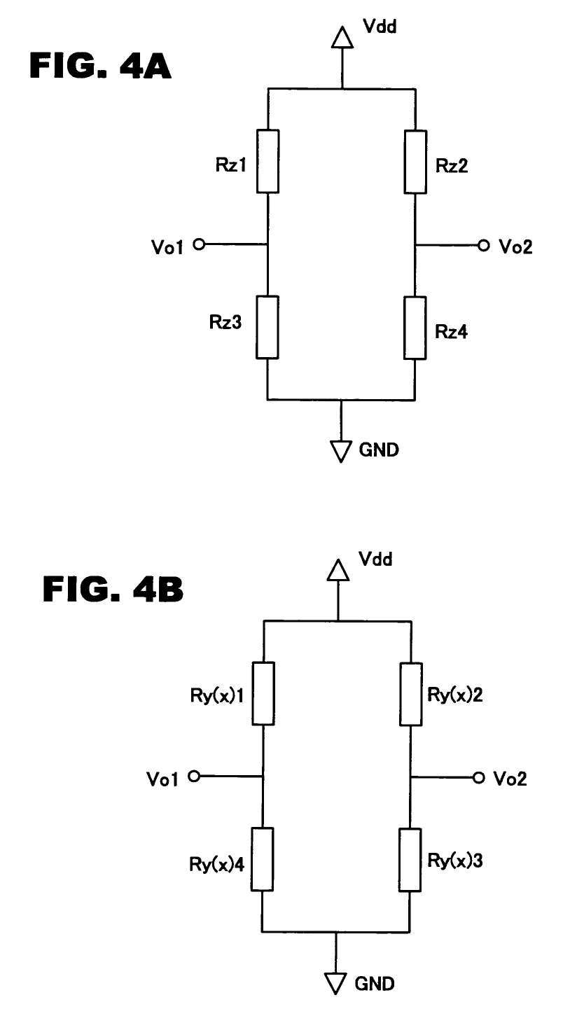

Acceleration applied to the acceleration sensor 110 in the Y-axis direction tilts the mass 118 to the Y-axis (X-axis similarly) direction, as shown in FIG. 3. At this time, tensile stress is generated in the piezo resistors RY1(RX1) and RY3(RX3), while compressive stress is generated in the piezo resistors RY2(RX2) and RY4(RX4). By the bridge circuit as shown in FIG. 4B, the variation of a resistor value is output as a variation of voltage (Vo1-Vo2) equivalent to the acceleration applied.

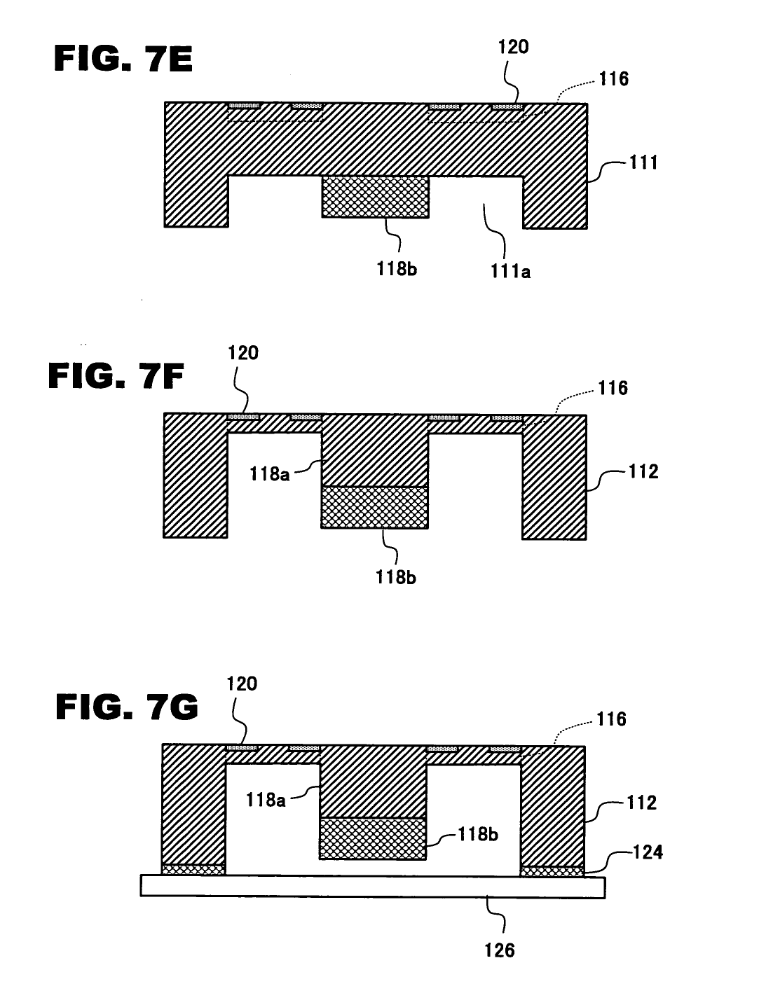

FIGS. 7A-7G are the schematic diagrams showing fabricating processes of a semiconductor three-dimensional acceleration sensor 110 related to the present invention. First of all, a semiconductor substrate 111 is prepared (FIG. 7A), and piezo resistors 120 are formed in the proximity of the surface using ion implantation (FIG. 7B). Then the semiconductor substrate 111 is etched from the surface side to form patterns of beams 116 (FIG. 7C).

Then the semiconductor substrate 111 is etched from the back face side to form a concave section 111a (FIG. 7D). The etched amount shall be equivalent to the thickness of a second mass portion 118b to be stacked. Then a second mass portion 118b is formed within the concave section 111a (FIG. 7E). The second mass portion 118b is composed of material having a higher specific gravity than silicon, such as gold, tungsten or nickel. The second mass portion 118b is formed by means of stacking method capable of providing a sufficient thickness, such as plating. The stacking method of the second mass portion 118b is not limited to plating but may include sputtering and deposition.

For forming the second mass portion 118b by means of plating, a desired thickness can be obtained by forming a substrate metallic layer in the concave section 111a and then a metallic layer is grown by electroplating onto the substrate metallic layer in the thickness direction. For obtaining a sufficient thickness, plating is more suitable than sputtering or deposition. Thus it is preferable to select a suitable method for forming a second mass portion 118b according to the material, specific gravity and required thickness of the mass portion 118b.

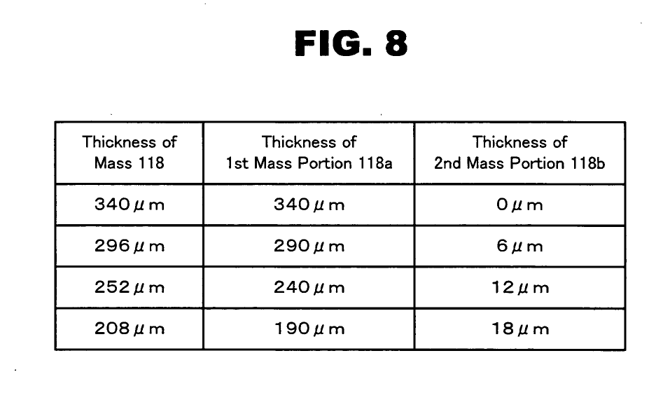

If a first mass portion 118a is formed of silicon and a second mass portion 118b is formed of gold, specific gravity (of silicon: gold) is approx. 1:8. FIG. 8 shows the thickness of a first mass portion 118a and a second mass portion 118b for obtaining sensitivity equivalent to that using a mass 118 formed only of silicon (a first mass portion) (thickness: 340 μm).

Then the semiconductor substrate 111 is etched from the back face side so as to make through openings in parts of the semiconductor substrate 111 to form patterns of a mass 118 (a first mass portion 118a) and an outer frame 112 (FIG. 7F). And then, the chip is cut into pieces by cutting technique, and the underside of the outer frame 112 is firmly fixed to the bottom of a package 126 and the base secured to the package using dice bonding material 124 (FIG. 7G).

Photolithography, which is used in semiconductor fabrication, is used to form patterns in the respective processes. This realizes high accuracy processing of each section. A second mass portion 118b is also formed using such semiconductor fabricating technology, thereby suppressing the positional shift with the first mass portion 118a. Thus mass production of sensors with stable characteristics is enabled.

Notwithstanding the foregoing description of its embodiments, the present invention is not limited to these embodiments, and those skilled in the art can make various changes and modifications to the invention, without departing from the scope and spirit of the claims. The order of steps in the sequence is not limited to that stated here. In the present embodiment, for example, etching for forming a mass 118a (FIG. 7F) follows etching for forming beams 116 (FIG. 7C). Etching for forming beams 116 (FIG. 7C) may follow etching for forming a mass 118a (FIG. 7F).

According to another aspect of the present invention, a method of fabricating a three-dimensional semiconductor acceleration sensor comprising:

forming piezo resistors in the proximity of the surface of a semiconductor substrate, said piezo resistors detecting acceleration in X, Y and Z axes, respectively;

forming four beam portions by processing said semiconductor substrate from the surface side, wherein said piezo resistors are formed in said four beam portions;

forming a step difference section by processing said semiconductor substrate from the back face side, wherein said step difference section is formed in the region where a mass portion will be formed;

forming a second mass portion by stacking material onto a part of the step difference by means of plating, said material having a higher specific gravity than the semiconductor substrate; and

forming a first mass portion by processing the semiconductor substrate from the back face side so as to leave said second mass portion, said first mass portion supported by said beam portions, wherein

said mass portion comprises a first mass portion formed by said semiconductor substrate and a second mass portion.

In the above-described method, the second mass portion may be stacked onto said first mass portion by plating. The second mass portion may be made of gold, tungsten or nickel.

What is claimed is:

1. A semiconductor acceleration sensor fabricated using a semiconductor substrate, comprising:
an outer frame formed by said semiconductor substrate;
a plurality of beam portions formed by said semiconductor substrate, said plurality of beam portions being connected to said outer frame;
a first mass portion formed by said semiconductor substrate, said first mass portion being connected to said beam portion; and
a second mass portion connected to the end face opposite to the beam portion of said first mass portion, wherein
said second mass portion is formed of material having a higher specific gravity than said first mass portion.

2. A semiconductor acceleration sensor according to claim 1, wherein
said second mass portion is formed of metal.

3. A semiconductor acceleration sensor according to claim 2, wherein
said metal is of gold, tungsten or nickel.

4. A semiconductor acceleration sensor according to claim 2, wherein
said second mass portion is formed by plating.

5. A semiconductor acceleration sensor according to claim 3, wherein
said second mass portion is formed by plating.

6. A three-dimensional semiconductor acceleration sensor fabricated using a semiconductor substrate and detecting acceleration in three axes (X, Y and Z), comprising:
an outer frame section composed of said semiconductor substrate, said outer frame section having through openings in Z-axis direction in the central portion;
a first mass portion composed of said semiconductor substrate, said first mass portion positioned in the interior section with a certain distance from said outer frame in X- and Y-axis directions, said first mass portion having a thickness in Z axis approximately equivalent to that of said outer frame;
four thin beam portions in Z axis composed of said semiconductor substrate, said four thin beam portions being in a plane perpendicular to the Z-axis direction of said outer frame section as well as in almost the same plane as that perpendicular to the Z-axis direction of said outer frame section, said four thin beam portions supporting said mass portion from the interior of said outer frame section in the X- and Y-axis directions, wherein
a second mass portion is stacked onto said first mass portion in a plane perpendicular to the Z-axis direction not connected to said four beams, said second mass portion having a higher specific gravity than said first mass portion.

7. A three-dimensional semiconductor acceleration sensor according to claim 6, wherein
said second mass portion is stacked onto said first mass portion by plating.
